(19) United States
(12) Patent Application Publication
(10) Pub. No.: US 2025/0358379 A1
(43) Pub. Date: Nov. 20, 2025

(54) SHEET CONVEYANCE APPARATUS, IMAGE READING APPARATUS, AND IMAGE FORMING APPARATUS

(71) Applicant: CANON KABUSHIKI KAISHA, Tokyo (JP)

(72) Inventor: TAKAYUKI FUKUSHIMA, Ibaraki (JP)

(21) Appl. No.: 19/199,874

(22) Filed: May 6, 2025

(30) Foreign Application Priority Data
May 14, 2024 (JP) 2024-078952

(51) Int. Cl. H04N 1/10; G03G 15/22

(52) U.S. Cl. CPC H04N 1/10; G03G 15/228

(57) ABSTRACT

A sheet conveyance apparatus includes a conveyance member, a separation member, a drive roller including a plurality of first rotating members, a motor, a follower roller including a plurality of second rotating members and a shaft member supporting the plurality of second rotating members, a holder member configured to regulate a position of a central second rotating member, and an urging spring configured to urge the holder member. The holder member includes (i) a first side surface portion provided with a first shaft-receiving portion and (ii) a second side surface portion provided with a second shaft-receiving portion. The holder member is configured to regulate the position of the central second rotating member by the first side surface portion and the second side surface portion and apply an urging force of the urging spring to the shaft member via the first shaft-receiving portion and the second shaft-receiving portion.

### BACKGROUND OF THE INVENTION

### Field of the Invention

The present disclosure relates to a sheet conveyance apparatus that conveys a sheet, an image reading apparatus that reads an image from a sheet, and an image forming apparatus that forms an image on a recording material.

### Description of the Related Art

Japanese Patent Application Laid-open No. 2023-054431 A discloses an image reading apparatus capable of reading an image while conveying a small-size document such as a business card. In this image reading apparatus, a document fed from a document tray by a feed roller passes through a separating portion and is conveyed toward a reading unit by a conveyance roller pair. The conveyance roller pair includes a drive roller having a plurality of roller elements provided at intervals in the width direction, and a follower roller having a plurality of roller elements provided at intervals in the width direction.

In the above document, the normal-size document is conveyed while being nipped by all of the plurality of roller elements of the drive roller and the plurality of roller elements of the follower roller, and the small-size document is nipped only by the roller element at the center of the drive roller and the roller element at the center of the follower roller. Therefore, the conveyance force applied to the small-size document by the conveyance roller pair is smaller than the conveyance force applied to the normal-size document by the conveyance roller pair. Then, the stability of document conveyance may be deteriorated depending on the relationship between the conveyance force applied to the document by the conveyance roller pair and the frictional resistance received by the document in the separating portion.

### SUMMARY OF THE INVENTION

The present invention provides a sheet conveyance apparatus capable of more stably conveying a small-size sheet.

An aspect of the invention provides a sheet conveyance apparatus including a conveyance member configured to convey a sheet, a separation member configured to form a separating portion together with the conveyance member and separate sheets one by one in the separating portion, a drive roller disposed downstream of the separating portion in a sheet conveyance direction, the drive roller including a plurality of first rotating members arranged in a sheet width direction orthogonal to the sheet conveyance direction, a motor configured to drive the drive roller, a follower roller configured to rotate following the drive roller, the follower roller including a plurality of second rotating members that come into contact with the plurality of first rotating members respectively and a shaft member supporting the plurality of second rotating members, a holder member configured to regulate a position of a central second rotating member disposed at a center in the sheet width direction among the plurality of second rotating members, and an urging spring configured to urge the holder member such that the plurality of second rotating members is brought into pressure contact with the plurality of first rotating members, wherein the holder member includes (i) a first side surface portion facing an end face on one side of the central second rotating member in the sheet width direction and provided with a first shaft-receiving portion that receives the shaft member and (ii) a second side surface portion facing an end face on another side of the central second rotating member in the sheet width direction and provided with a second shaft-receiving portion that receives the shaft member, and wherein the holder member is configured to regulate the position of the central second rotating member in the sheet width direction by the first side surface portion and the second side surface portion and apply an urging force of the urging spring to the shaft member via the first shaft-receiving portion and the second shaft-receiving portion.

Another aspect of the invention provides a sheet conveyance apparatus including a conveyance member configured to convey a sheet, a separation member configured to form a separating portion together with the conveyance member and separate sheets one by one in the separating portion, a drive roller disposed downstream of the separating portion in a sheet conveyance direction, the drive roller including a plurality of first rotating members arranged in a sheet width direction orthogonal to the sheet conveyance direction, a motor configured to drive the drive roller, a follower roller configured to rotate following the drive roller, the follower roller including a plurality of second rotating members that come into contact with the plurality of first rotating members respectively and a shaft member supporting the plurality of second rotating members, a holder member configured to regulate positions of two second rotating members disposed at a central portion in the sheet width direction among the plurality of second rotating members, and an urging spring configured to urge the holder member such that the plurality of second rotating members is brought into pressure contact with the plurality of first rotating members, wherein the holder member includes (i) a first side surface portion facing one of the two second rotating members in the sheet width direction and provided with a first shaft-receiving portion that receives the shaft member and (ii) a second side surface portion facing another of the two second rotating members in the sheet width direction and provided with a second shaft-receiving portion that receives the shaft member, and wherein the holder member is configured to regulate the positions of the two second rotating members in the sheet width direction by the first side surface portion and the second side surface portion and apply an urging force of the urging spring to the shaft member via the first shaft-receiving portion and the second shaft-receiving portion.

Another aspect of the invention provides a sheet conveyance apparatus including a conveyance member configured to convey a sheet, a separation member configured to form a separating portion together with the conveyance member and separate sheets one by one in the separating portion, a drive roller disposed downstream of the separating portion in a sheet conveyance direction, the drive roller including a plurality of first rotating members arranged in a sheet width direction orthogonal to the sheet conveyance direction, a motor configured to drive the drive roller, a follower roller configured to rotate following the drive roller, the follower roller including a plurality of second rotating members that come into contact with the plurality of first rotating members respectively and a shaft member supporting the plurality of second rotating members, a holder member configured to cover, from a side opposite to the drive roller, a central second rotating member disposed at a center in the sheet width direction among the plurality of second rotating members, and an urging spring configured to urge the holder member such that the plurality of second rotating members is brought into pressure contact with the plurality of first rotating members, wherein the urging spring is the only urging spring by which the follower roller is urged such that the plurality of first rotating members and the plurality of second rotating members are brought into pressure contact with each other.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to a first embodiment.

FIG. 2 is a perspective view of an image reading apparatus according to the first embodiment.

FIG. 3 is a schematic diagram of the image reading apparatus according to the first embodiment.

FIG. 4 is a cross-sectional view of an ADF according to the first embodiment.

FIG. 5 is a view illustrating the inside of the ADF according to the first embodiment.

FIG. 6A is a cross-sectional view of the ADF according to the first embodiment.

FIG. 6B is a perspective view of a follower roller holder according to the first embodiment.

FIG. 7 is a cross-sectional view of an ADF according to a second embodiment.

### DESCRIPTION OF THE EMBODIMENTS

Hereinafter, embodiments according to the present disclosure will be described with reference to the drawings.

### First Embodiment

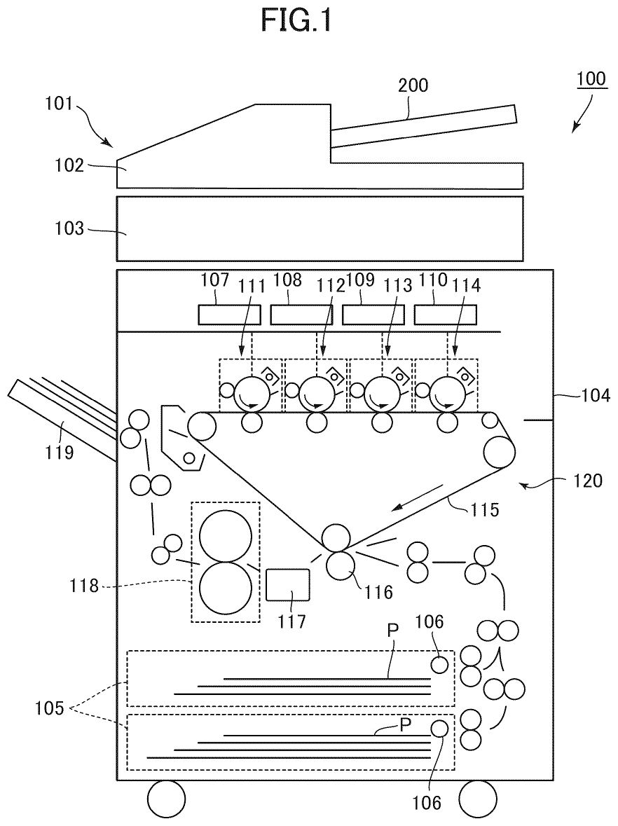

First, an image forming apparatus 100 and an image reading apparatus 101 according to a first embodiment will be described with reference to FIGS. 1 to 3. The image forming apparatus 100 is an electrophotographic multifunction printer having a copying function of reading an image from a document by the image reading apparatus 101 and forming an image on a recording material P based on acquired image information. However, the “image forming apparatus” may be a single-function printer with only a printing function, a facsimile machine, a commercial printer, or the like. Furthermore, the “image forming apparatus” may be, for example, an inkjet printer including an inkjet type printing unit as an image forming portion.

FIG. 1 is a schematic diagram of the image forming apparatus 100 according to the first embodiment. The image forming apparatus 100 includes a printer body 104 as an image forming apparatus body, and the image reading apparatus 101 disposed above the printer body 104. The printer body 104 includes an image forming portion 120 that is an electrophotographic image forming engine, a feeding cassette 105 that accommodates the recording material P, a conveyance mechanism that conveys the recording material P, and a sheet discharge tray 119. As the recording material P (recording medium), various sheet materials having different sizes and materials, such as paper including plain paper and thick paper, a sheet material subjected to surface treatment such as coated paper, a sheet material having a special shape such as an envelope and index paper, a plastic film, cloth, and the like, can be used.

The image forming portion 120 includes image forming units 111, 112, 113, and 114 (process units), exposure units 107, 108, 109, and 110, a transfer unit, and a fixing unit 118. Each of the image forming units 111 to 114 includes a photosensitive drum as an image bearing member (photosensitive member), and a charging unit, a developing unit, and a cleaning unit that act on the photosensitive drum to perform each step of charging, developing, and cleaning in an electrophotographic process. The transfer unit includes an intermediate transfer belt 115 as an intermediate transfer member, a secondary transfer roller 116 that forms a secondary transfer portion together with the intermediate transfer belt 115, and a primary transfer roller facing each photosensitive drum with the intermediate transfer belt 115 interposed therebetween. The fixing unit 118 includes, for example, a fixing roller pair and a halogen lamp as a heat source.

The image forming apparatus 100 executes a series of operations (image forming operation) of forming an image while conveying the recording material P as follows. For example, in a case where the user presses a print execution button (copy button) of an operation unit in a state where a document is set on a document tray 200 of the image reading apparatus 101, the image forming apparatus 100 executes the image forming operation as well as a reading operation by the image reading apparatus 101.

In the image forming operation, the photosensitive drum and the intermediate transfer belt 115 of each image forming unit 111 to 114 are rotationally driven. The surface of each photosensitive drum is uniformly charged by the charging unit. The exposure units 107 to 110 expose the surfaces of the photosensitive drums based on image information received from the image reading apparatus 101 or a host computer connected to the image forming apparatus 100 via a network. As a result, an electrostatic latent image corresponding to a monochrome image is formed on the surface of each photosensitive drum. The developing unit of each image forming unit 111 to 114 develops the electrostatic latent image into a toner image using one of yellow, magenta, cyan, and black toners (developers). Further, the toner image is transferred from the photosensitive drum to the intermediate transfer belt 115 by the primary transfer roller. At this time, multiple transfer is performed so that the toner images of the respective colors overlap each other, whereby a full-color toner image (hereinafter, simply referred to as a toner image) is formed on the intermediate transfer belt 115. The rotation of the intermediate transfer belt 115 conveys the toner image toward the secondary transfer portion.

On the other hand, the recording material P is fed from the feeding cassette 105 by the feeding roller 106 and conveyed toward the secondary transfer portion. In the secondary transfer portion, the toner image is transferred from the intermediate transfer belt 115 to the recording material P by the secondary transfer roller 116 to which a predetermined transfer voltage is applied. The recording material P having passed through the secondary transfer portion is conveyed to the fixing unit 118 by a pre-fixing conveyance unit 117, and undergoes a fixing process of heating and pressurizing the toner image. The recording material P having passed through the fixing unit 118 is discharged as a product and stacked on the sheet discharge tray 119.

### Image Reading Apparatus

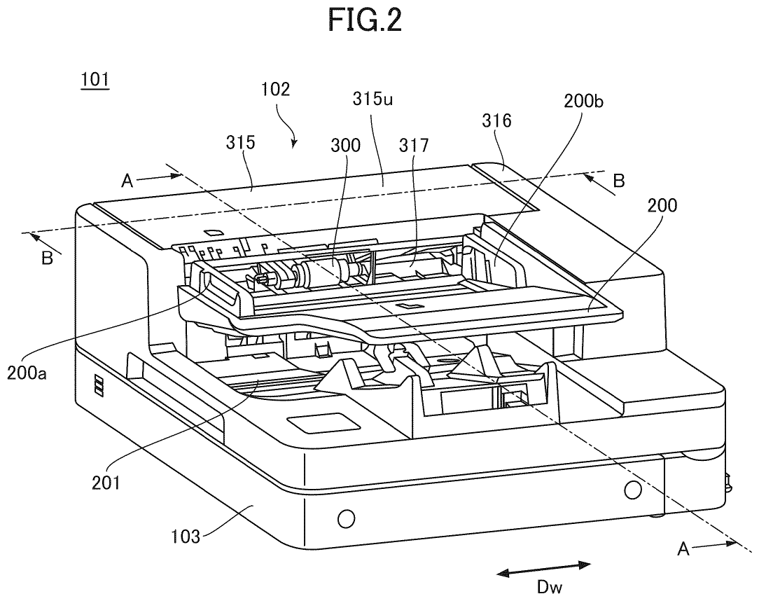

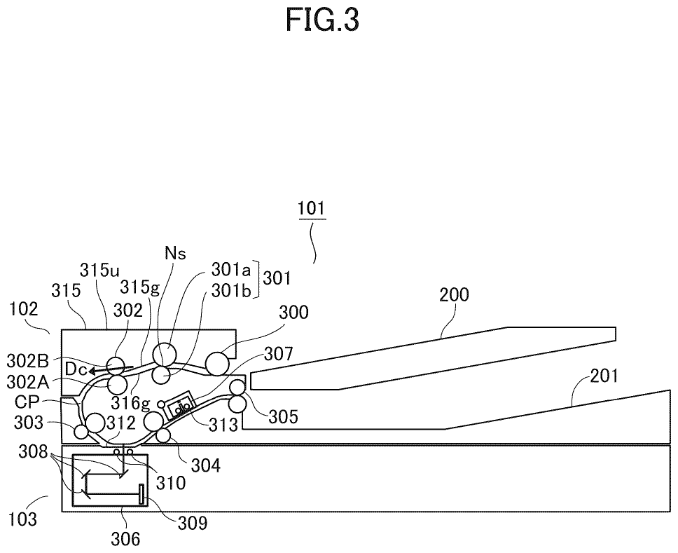

Next, the image reading apparatus 101 will be described with reference to FIGS. 2 and 3. The image reading apparatus 101 roughly includes a reader 103 and an auto document feeder 102 (hereinafter, referred to as an ADF 102) as a sheet conveyance apparatus according to the present embodiment. The reader 103 is fixed to an upper portion of the printer body 104. The ADF 102 is supported by the reader 103 and is provided so as to be openable and closable with respect to the reader 103.

As illustrated in FIGS. 2 and 3, the reader 103 includes a front side reading unit 306 and a feeding-reading glass 312. The front side reading unit 306 includes a light source 310, a substrate 309 on which a charge coupled device (CCD) as a light receiving element is disposed, and an optical system 308 that guides light from the document and forms an image on a light receiving surface of the light receiving element.

The ADF 102 includes a back side reading unit 307 and a feeding-reading glass 313. The back side reading unit 307 is an image sensor unit including a light source, a sensor substrate on which a CMOS circuit as a light receiving element is formed, and an optical system that forms an image of light from the document on a light receiving surface of the sensor substrate.

Each of the front side reading unit 306 and the back side reading unit 307 is an example of a reading unit that reads an image from a document as a sheet conveyed by the conveyance member of the ADF 102.

In addition, the ADF 102 includes the document tray 200, an opening/closing cover 315, a plurality of conveyance guides including a separation guide 317, a casing 316, and a sheet discharge tray 201. Further, the ADF 102 includes a pickup roller 300 (feeding roller), a separation roller pair 301, a drawing roller pair 302, a first read roller pair 303, a second read roller pair 304, and a sheet discharge roller pair 305 as conveyance members for conveying the document.

The opening/closing cover 315 serves as a second frame (second frame body) supported by the casing 316 serving as a first frame (first frame body) in an openable and closable manner. The opening/closing cover 315 includes an upper cover portion 315u that forms at least a part of the upper surface of the ADF 102, and a conveyance guide 316g (second guide portion) that forms at least a part of a conveyance path CP together with a conveyance guide 315g (first guide portion) provided in the casing 316. The opening/closing cover 315 is movable (pivotable) with respect to the casing 316 so that at least a part of the conveyance path CP is opened.

The pickup roller 300, the separation roller pair 301, the drawing roller pair 302, the first read roller pair 303, the second read roller pair 304, and the sheet discharge roller pair 305 are arranged in this order along the conveyance path CP. Hereinafter, the direction in which the document is conveyed along the conveyance path CP is referred to as a sheet conveyance direction Dc. A direction along the sheet and orthogonal to the sheet conveyance direction is referred to as a sheet width direction Dw. The sheet width direction Dw is substantially the same as the main scanning direction of the front side reading unit 306 and the back side reading unit 307 which are line sensors.

The document tray 200 is an example of a placement portion on which a document as a sheet is placed. The document tray 200 is supported by the casing 316. The pickup roller 300 is an example of a feed member that feeds a document from the document tray 200. The sheet discharge tray 119 is a stacking portion on which a document from which an image has been read is stacked. The sheet discharge roller pair 305 is an example of a discharge member that discharges the document from the inside to the outside of the ADF 102 toward the sheet discharge tray 119.

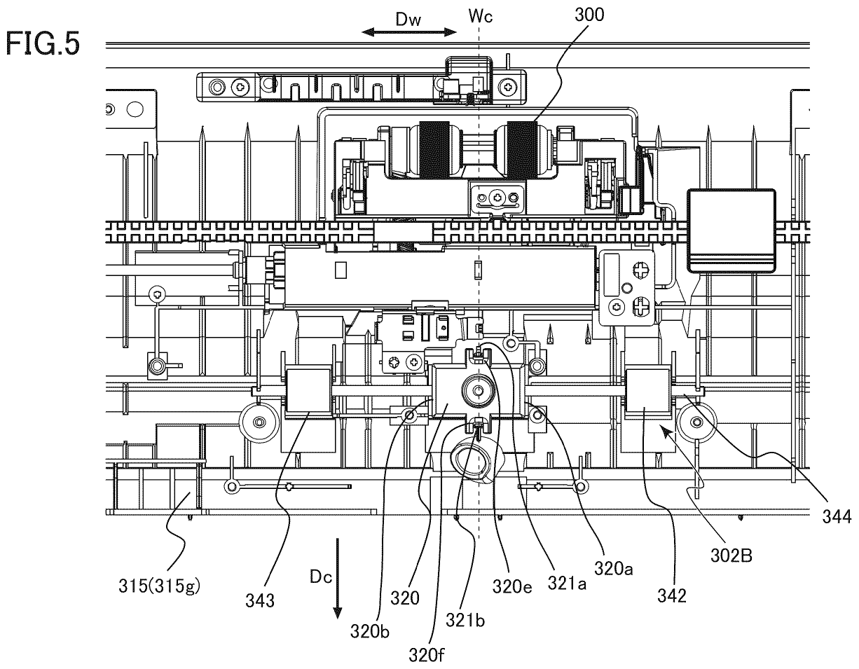

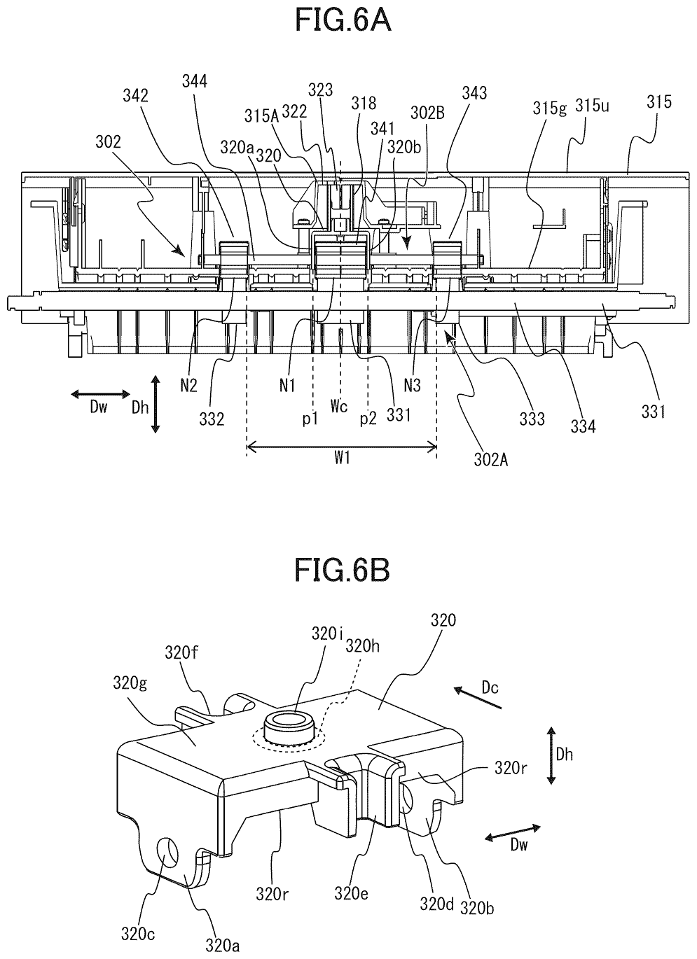

The document tray 200 is provided with side regulating plates 200a and 200b serving as a pair of regulation members that regulate the position of the document in the sheet width direction Dw. The side regulating plates 200a and 200b are connected via an interlocking mechanism such as a rack and pinion, and are configured to move in the sheet width direction Dw in a linked manner. Further, the side regulating plates 200a and 200b move while maintaining a symmetrical positional relationship with respect to the center of the document tray 200 in the sheet width direction Dw (that is, a state in which the distance from the regulating surface facing the side end of the document to the center of the document tray 200 is equal). The ADF 102 is a center-based sheet conveyance apparatus that conveys the document such that the center of the document in the sheet width direction Dw coincides with a conveyance center Wc (FIGS. 5, 6A, and 6B) with the center of the document tray 200 in the sheet width direction Dw as the conveyance center Wc. The conveyance center Wc is a reference of a sheet position in the sheet width direction Dw of the document conveyed by the ADF 102.

According to the present embodiment, a sheet such as a business card (hereinafter, referred to as a small-size document) having a short length in the sheet width direction Dw (hereinafter, referred to as a sheet width) can be placed on the document tray 200, and the ADF 102 can convey a small-size document. The small-size document is a sheet having a size smaller than a sheet size for general documents, and refers to, for example, a document of A6 size or less (a sheet width of 105 mm or less). The small-size document includes a document having a sheet width of 55 mm and a sheet length of 91 mm, which is the size of a general business card. Further, the side regulating plates 200a and 200b are movable to positions where the side regulating plates come in contact with both side ends of the business card size document. Note that, instead of the side regulating plates 200a and 200b, the width-direction position of the small-size document may be regulated by placing the small-size document on a dedicated auxiliary tray detachable from the document tray 200.

The separation roller pair 301 includes a feed roller 301a (FIG. 3) that conveys a document and a separation roller 301b that forms a separating portion Ns (separation nip) between the feed roller 301a and the separation roller 301b. The feed roller 301a is an example of a conveyance member that conveys a document in the sheet conveyance direction. The feed roller 301a is rotationally driven by a drive source (motor) common to the pickup roller 300. The separation roller 301b is an example of a separation member that separates the document by applying a frictional force to the document in the separating portion Ns. The separation guide 317 guides the leading end of the document fed by the pickup roller 300 toward the separating portion Ns.

The separation roller 301b is, for example, a roller member connected to a fixed shaft (non-rotating shaft member) supported by the casing 316 via a torque limiter. The separation member is not limited thereto, and for example, a pad-shaped elastic member (rubber pad) that comes into contact with the feed roller 301a or a retard roller to which a driving force (retard drive) in a direction opposite to the sheet conveyance direction is applied via a torque limiter may be used.

The drawing roller pair 302 is a conveyance unit that is downstream of the separation roller pair 301 in the sheet conveyance direction Dc and further conveys the document received from the separation roller pair 301 in the sheet conveyance direction Dc. In other words, the drawing roller pair 302 is a conveyance roller pair that conveys the document in the sheet conveyance direction Dc against the frictional force (frictional resistance) in the direction opposite to the sheet conveyance direction Dc received by the document from the separation roller 301b in the separating portion Ns.

The drawing roller pair 302 includes a drive roller 302A that receives driving force from a drive source disposed in the casing 316 and rotates, and a follower roller 302B that rotates following the drive roller 302A. A detailed configuration of the drawing roller pair 302 will be described below.

According to the present embodiment, the opening/closing cover 315 supports the pickup roller 300, the feed roller 301a of the separation roller pair 301, and the follower roller 302B of the drawing roller pair 302. The casing 316 supports a plurality of rollers including the separation roller 301b and the drive roller 302A of the drawing roller pair 302. In a state where the opening/closing cover 315 is closed, the conveyance path CP is formed, and the nip portion of the separation roller pair 301 and the drawing roller pair 302 is formed. In other words, the ADF 102 is allowed to convey the document in a state where the opening/closing cover 315 is closed.

A reading operation (feeding-reading operation) in which the image reading apparatus 101 reads an image while conveying the document by the ADF 102 will be described. In a case where a user sets a document on the document tray 200 and the user operates the operation unit to instruct execution of a reading operation, the reading operation starts. When the pickup roller 300 rotates in a state of being in contact with the upper surface of the uppermost document on the document tray 200, the uppermost document is fed toward the separation roller pair 301. The fed document is guided by the separation guide 317 to enter the separating portion Ns, and is further conveyed in the sheet conveyance direction Dc by the feed roller 301a. When a plurality of documents enters the separating portion Ns, the frictional force applied to the documents by the separation roller 301b prevents the documents other than the uppermost document from passing through the separating portion Ns. As a result, each document is conveyed on the conveyance path CP in a state of being separated one by one.

When the leading end of the document having passed through the separating portion Ns reaches the drawing roller pair 302, the document is further conveyed downstream in the sheet conveyance direction Dc by the drawing roller pair 302.

Here, the rotational driving of the pickup roller 300 and the feed roller 301a may be stopped before the trailing edge of the document in the sheet conveyance direction Dc passes through the separating portion Ns. With this configuration, it is possible to suppress movement of the subsequent document together with the document to be fed in the current feeding operation. Further, the conveyance speed of the drawing roller pair 302 (the circumferential speed of the drive roller 302A) may be set to be faster than the conveyance speed of the separation roller 301b (the circumferential speed of the feed roller 301a). Accordingly, it is possible to improve both the separation performance and the throughput of the reading operation in the separating portion Ns. Each of the above configurations may be applied alone or in combination. In a case where each of the above-described configurations is applied, it is preferable that the drawing roller pair 302 can apply a larger conveyance force to the document in order to stably convey the document against the frictional resistance received by the document at the separating portion Ns.

The document that has passed through the drawing roller pair 302 is conveyed via the first read roller pair 303 and the second read roller pair 304. In this process, at the reading position between the first read roller pair 303 and the second read roller pair 304, the front side reading unit 306 optically scans the first face of the document through the feeding-reading glass 312 to read the image information on the first side. In a case where the image information is to be read from both sides of the document, the back side reading unit 307 optically scans the second side of the document through the feeding-reading glass 313 at the reading position between the second read roller pair 304 and the sheet discharge roller pair 305, and reads the image information of the second side. The document from which the image information has been read is discharged to the outside of the casing 316 by the sheet discharge roller pair 305 and is stacked on the sheet discharge tray 201.

Note that the image reading apparatus 101 can execute an operation (fixed reading operation) of reading image information while moving the front side reading unit 306 in a sub-scanning direction in a state where the document is placed on the platen glass provided on the upper face of the reader 103 and the ADF 102 is closed.

### Pressing Configuration of Drawing Roller Pair

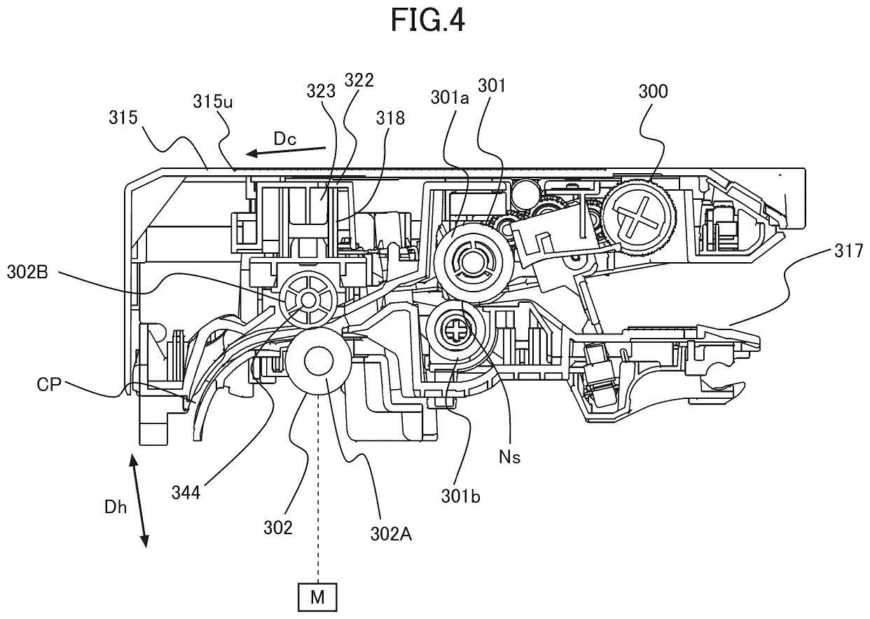

The configuration of the drawing roller pair 302 and the pressing configuration thereof according to the present embodiment will be described in detail with reference to FIGS. 4, 5, 6A, and 6B. FIG. 4 is a cross-sectional view illustrating a part of a cross section of the ADF 102 taken along the line A-A (a virtual plane along the conveyance center Wc) in FIG. 2. FIG. 5 is a view illustrating the inside of the opening/closing cover 315, and is a top view illustrating a state in which the ADF 102 is viewed from above through the upper cover portion 315u of the opening/closing cover 315. FIG. 6A is a cross-sectional view illustrating a part of a cross section of the ADF 102 taken along the line B-B in FIG. 2. FIG. 6A illustrates a cross section of the ADF 102 in a virtual plane including the rotation axis of the drive roller 302A of the drawing roller pair 302 and the rotation axis of the follower roller 302B. FIG. 6B is a perspective view of a follower roller holder 320.

As illustrated in FIGS. 4 and 6A, the drawing roller pair 302 includes the drive roller 302A and the follower roller 302B. In addition, the ADF 102 includes the follower roller holder 320 that comes into contact with the follower roller 302B, and a pressure spring 318 as an urging member or urging spring for pressing the follower roller holder 320 to press the nip portion. The conveyance unit according to the present embodiment includes the drawing roller pair 302, the follower roller holder 320, and the pressure spring 318.

The drive roller 302A includes drive roller elements 331, 332, and 333 as a plurality of first rotating members arranged in the sheet width direction Dw, and a drive shaft 334 as a shaft member that supports the drive roller elements 331 to 333. The drive roller elements 331 to 333 are attached to the drive shaft 334 and rotates integrally with the drive shaft 334. An input gear to which a driving force from a motor M as a drive source is input is provided at an end of the drive shaft 334. The drive roller 302A is rotationally driven by the drive force of the motor M. Each of the drive roller elements 331 to 333 is exposed to the conveyance path CP through an opening formed in the conveyance guide 316g.

The follower roller 302B includes follower roller elements 341, 342, and 343 as a plurality of second rotating members arranged in the sheet width direction Dw, and a driven shaft 344 as a shaft member that supports the follower roller elements 341 to 343. The follower roller elements 341 to 343 are rotatably supported by the driven shaft 344. Although the follower roller elements 341 to 343 are freely rotatably fitted to the driven shaft 344, the follower roller elements 341 to 343 may rotate integrally with the driven shaft 344. Each of the follower roller elements 341 to 343 is exposed to the conveyance path CP through an opening formed in the conveyance guide 315g. The follower roller elements 341 to 343 are disposed at a position corresponding to the drive roller elements 331 to 333 and are in contact with the drive roller elements 331 to 333.

The driven shaft 344 is rotatably supported by the conveyance guide 315g on the side opposite to the conveyance surface of the conveyance guide 315g. The opening/closing cover 315 has, for example, ribs provided with shaft-receiving portions protruding in the height direction Dh from surface of the conveyance guide 315g on the opposite side to the conveyance surface and rotatably supporting both ends of the driven shaft 344.

The drive roller elements 331 to 333 and the follower roller elements 341 to 343 are rotating members (serving as rolling members, roller bodies) having outer peripheral surfaces that can come into contact with the document to be conveyed. The drawing roller pair 302 is configured to nip and convey the document with at least one of a plurality of nip portions N1, N2, and N3 formed between the drive roller elements 331 to 333 and the follower roller elements 341 to 343.

According to the present embodiment, the drive roller 302A includes the three drive roller elements 331 to 333, and the follower roller 302B includes the three follower roller elements 341 to 343. The drive roller element 331 is located at the center in the sheet width direction Dw among the plurality of drive roller elements 331 to 333. The drive roller elements 332 and 333 are located at both ends in the sheet width direction Dw among the plurality of drive roller elements 331 to 333. Similarly, the follower roller element 341 is located at the center in the sheet width direction Dw among the plurality of follower roller elements 341 to 343. The follower roller elements 342 and 343 are located at both ends in the sheet width direction Dw among the plurality of follower roller elements 341 to 343.

According to the present embodiment, the central drive roller element 331 and the central follower roller element 341 are arranged on the above-described conveyance center Wc in the sheet width direction Dw. On the other hand, the drive roller elements 332 and 333 at both ends and the follower roller elements 342 and 343 at both ends are positioned outside an area through which the small-size document passes in the sheet width direction Dw for at least a part of the small-size document that can be conveyed by the ADF 102. In other words, the sheet width of the minimum size document that can be conveyed by the ADF 102 (i.e., a sheet having a shortest length in the sheet width direction among the sheets conveyable by the ADF 102) is shorter than the interval W1 (FIG. 5) from the follower roller element 342 adjacent to one side of the central follower roller element 341 to the follower roller element 343 adjacent to the other side of the central follower roller element 341. Therefore, at least some small-size documents are nipped only by the nip portion N1 at the center among the three nip portions N1 to N3 of the drawing roller pair 302. Note that the A4 size document is nipped by all of the three nip portions N1 to N3.

The number of drive roller elements (serving as first rotating members) and the number of follower roller elements (serving as second rotating members) included in the drive roller 302A and the follower roller 302B are not limited to three each. As in a second embodiment described below, the number may be four or five or more. In a case where the number of the follower roller elements is an odd number, the same configuration as that of the present embodiment can be suitably applied.

As illustrated in FIGS. 5 and 6A, the follower roller holder 320 (serving as a holder member, a regulation member, and a shaft-receiving member) is attached to the driven shaft 344 of the follower roller 302B. As illustrated in FIG. 6B, the follower roller holder 320 includes a first side surface portion 320a, a second side surface portion 320b, a base portion 320g, groove portions 320e and 320f, a protrusion portion 320i, a rib portion 320r, shaft-receiving holes 320c and 320d, and a spring receiving region 320h. The follower roller holder 320 having the above portions can be integrally molded with a resin material.

Hereinafter, a direction orthogonal to both the sheet width direction Dw and the sheet conveyance direction Dc at the nip portion of the drawing roller pair 302 is referred to as a height direction Dh. The height direction Dh is a direction along a straight line connecting the rotation axis of the drive roller 302A and the rotation axis of the follower roller 302B. In addition, the direction in which the follower roller 302B is located with respect to the drive roller 302A in the height direction Dh may be referred to as “an upper side in the height direction Dh”, and the opposite direction may be referred to as “a lower side in the height direction Dh”.

The base portion 320g has a plate shape extending in the sheet width direction Dw and the sheet conveyance direction Dc. The base portion 320g covers the follower roller element 341 at the center when viewed from the upper side in the height direction Dh. The protrusion portion 320i protrudes upward in the height direction Dh from the base portion 320g. The protrusion portion 320i is a substantially cylindrical or column shaped projecting portion for holding an end of pressure spring 318. The spring receiving region 320h is a region around the protrusion portion 320i in the base portion 320g.

The first side surface portion 320a and the second side surface portion 320b extend downward in the height direction Dh respectively from one end and another end of the base portion 320g in the sheet width direction Dw. The first side surface portion 320a and the second side surface portion 320b extend along the sheet conveyance direction Dc. The first side surface portion 320a faces an end face on one side in the sheet width direction Dw of the central follower roller element 341 (FIG. 6A). The second side surface portion 320b faces the end face on the other side in the sheet width direction Dw of the central follower roller element 341. The follower roller holder 320 can regulate the position of the central follower roller element 341 in the sheet width direction Dw by the first side surface portion 320a and the second side surface portion 320b. The follower roller holder 320 functions as a cover member that covers the drive roller 302A from the opposite side (upper side) to the drive roller 302A.

The shaft-receiving hole 320c as a first shaft-receiving portion is formed in the first side surface portion 320a, and the shaft-receiving hole 320d as a second shaft-receiving portion is formed in the second side surface portion 320b. The shaft-receiving holes 320c and 320d are substantially circular holes penetrating the first side surface portion 320a and the second side surface portion 320b, respectively. The driven shaft 344 is inserted into the shaft-receiving holes 320c and 320d. The first shaft-receiving portion and the second shaft-receiving portion are not limited to the through holes, and may have, for example, a concave shape in which a part of the lower edge of the first side surface portion 320a and the second side surface portion 320b in FIG. 6B is recessed upward in a semicircular shape.

The groove portions 320e and 320f have a recessed shape opened in a direction intersecting the sheet width direction Dw when viewed in the height direction Dh and a groove shape extending along the height direction Dh. The groove portions 320e and 320f are guided portions that engage with the two guide shapes 321a and 321b (FIG. 5) provided in the opening/closing cover 315. The guide shapes 321a and 321b extend along a direction (preferably the height direction Dh) intersecting both the sheet width direction Dw and the sheet conveyance direction Dc. The guide shapes 321a and 321b have a width substantially equal to (or slightly narrower than) the inner width of the groove portions 320e and 320f in the sheet width direction Dw, and extend in the height direction Dh. The guide shapes 321a and 321b are formed integrally with the conveyance guide 315g by, for example, a resin material.

The guided portion of the follower roller holder 320 may be a projecting portion protruding toward the upstream side or the downstream side in the sheet conveyance direction Dc. In this case, the guide shape of the opening/closing cover 315 may be a concave shape engaged with the projecting portion and a groove shape extending along the height direction Dh.

The follower roller holder 320 is movable in the height direction Dh with respect to the opening/closing cover 315. In other words, the follower roller holder 320 is movable with respect to the opening/closing cover 315 (second frame) such that the rotation axis of the follower roller 302B approaches to and moves away from the rotation shaft of the drive roller 302A. When the groove portions 320e and 320f are engaged with the guide shapes 321a and 321b, the position of the follower roller holder 320 in the sheet width direction Dw is restricted.

Further, the position of the follower roller holder 320 in the sheet width direction Dw is regulated, so that the position of the central follower roller element 341 regulated by the follower roller holder 320 in the sheet width direction Dw with respect to the opening/closing cover 315 is regulated. Thus, for example, the positioning accuracy (alignment) of the follower roller element 341 at the center in the sheet width direction Dw can be improved with respect to other conveying rollers supported by the conveyance guide 315g and the opening/closing cover 315.

In the case of a small-size document, since the drawing roller pair 302 nips the document only with the central nip portion N1, the document tends to be swiveled and skew feeding easily occurs during conveyance as compared with an A4 size document nipped by the plurality of nip portions N1 to N3. Since the positioning accuracy of the central follower roller element 341 is improved, particularly in a case where a small-size document is conveyed, it is possible to reduce the occurrence of skew feeding of the document while the document is conveyed by the drawing roller pair 302.

The positions of the follower roller elements 342 and 343 other than the center in the sheet width direction Dw are restricted by, for example, ribs provided on the opening/closing cover 315. The follower roller elements 342 and 343 may be positioned with respect to the driven shaft 344 in the sheet width direction Dw.

According to the present embodiment, two guide shapes 321a and 321b are arranged on the upstream side and the downstream side in the sheet conveyance direction Dc with respect to the follower roller holder 320. In a case where one guide shape 321a is a first guide shape, the other guide shape 321b can be referred to as a second guide shape. Since the two guide shapes 321a and 321b face the bottom portions of the groove portions 320e and 320f, the position of the follower roller holder 320 in the sheet conveyance direction Dc is restricted. By restricting the position of the follower roller holder 320, the positions of the driven shaft 344 and the follower roller elements 341 to 343 in the sheet conveyance direction Dc are restricted.

According to the present embodiment, one groove portion 320e and one groove portion 320f are disposed on each of the upstream and downstream side surfaces of the follower roller holder 320 in the sheet conveyance direction Dc. Further, according to the present embodiment, both the groove portions 320e and 320f and the guide shapes 321a and 321b are disposed on the conveyance center Wc in the sheet width direction Dw. However, the positions and the number of the groove portions 320e and 320f can be changed.

The rib portion 320r is a projecting portion which projects in the height direction Dh from the base portion 320g and extends in the sheet width direction Dw between the first side surface portion 320a and the second side surface portion 320b. Although only the rib portion 320r provided at the upstream end of the base portion 320g in the sheet conveyance direction Dc is illustrated in FIG. 6B, a similar rib portion 320r is also provided at the downstream end of the base portion 320g. The rib portion 320r functions as a reinforcing rib that can efficiently transmit the spring force (urging force) of the pressure spring 318 to the driven shaft 344 by increasing the stiffness of the follower roller holder 320. The rib portion 320r is preferably formed continuously in the sheet width direction Dw from the first side surface portion 320a to the second side surface portion 320b.

Next, the pressurization of the drawing roller pair 302 by the pressure spring 318 will be described. As illustrated in FIGS. 4 and 6A, the pressure spring 318 is disposed between the opening/closing cover 315 and the follower roller holder 320, and presses the follower roller holder 320 downward in the height direction Dh. The follower roller holder 320 transmits the spring force of the pressure spring 318 to the driven shaft 344 by pressing the driven shaft 344 with the wall surfaces of the shaft-receiving holes 320c and 320d. With this configuration, the follower roller elements 341 to 343 are brought into pressure contact with the drive roller elements 331 to 333, and a nip pressure is generated in the nip portions N1 to N3.

In other words, the spring force of the pressure spring 318 is transmitted to the driven shaft 344 that supports the plurality of follower roller elements 341 to 343. Therefore, the plurality of follower roller elements 341 to 343 (serving as the plurality of second rotating members) can be brought into pressure contact with the plurality of drive roller elements 331 to 333 (serving as the plurality of first rotating members) by one pressure spring 318 (one pressure member).

The configuration of the pressure spring 318 will be further described. The pressure spring 318 which serves as an urging member according to the present embodiment is a compression coil spring. However, a plate spring or a rubber member can also be used as the urging member.

The pressure spring 318, which is a compression coil spring, is disposed with its central axis oriented in the height direction Dh. One end of the pressure spring 318 in the height direction Dh is in contact with the spring receiving portion 322 provided in the opening/closing cover 315, and the other end of the pressure spring 318 is in contact with the spring receiving region 320h of the follower roller holder 320. The spring receiving region 320h is a pressed region where the follower roller holder 320 receives the force from the pressure spring 318. The spring receiving portion 322 of the opening/closing cover 315 is provided, for example, on a bracket 315A fixed to the conveyance guide 315g with a screw or the like. The spring receiving portion 322 may be formed integrally with other portions of the opening/closing cover 315. The bracket 315A includes a protrusion 323 to which the pressure spring 318 can be attached by press-fitting one end of the pressure spring 318.

The pressure spring 318 is disposed on the conveyance center Wc in the sheet width direction Dw. In other words, a part of the pressure spring 318 exists on the conveyance center Wc in the sheet width direction Dw. Preferably, the position of the central axis of the pressure spring 318, which is a compression coil spring, in the sheet width direction Dw is configured to coincide with the conveyance center Wc except for an unavoidable error such as assembly tolerance.

According to the present embodiment, the pressure spring 318 is the only urging member by which the drive roller 302A or the follower roller 302B is urged so that the plurality of drive roller elements 331 and the plurality of follower roller elements 341 are brought into pressure contact with each other. An urging member for urging the follower roller 302B toward the drive roller 302A is not provided other than the pressure spring 318. Further, an urging member for urging the drive roller 302A toward the follower roller 302B is not disposed either. In other words, the pressure spring 318 is the only urging member by which the drive roller or the follower roller is urged so that the plurality of first rotating members and the plurality of second rotating members are brought into pressure contact with each other.

According to the present embodiment, the plurality of nip portions N1 to N3 can be pressed by a simple configuration using the single pressure spring 318 (serving as an urging member).

### Summary of the Present Embodiment

According to the present embodiment, the plurality of follower roller elements 341 to 343 (serving as the plurality of second rotating members) are brought into pressure contact with the plurality of drive roller elements 331 to 333 (serving as the plurality of first rotating members) by the spring force of one pressure spring 318 (serving as an urging member). In the follower roller holder 320, the first side surface portion 320a and the second side surface portion 320b regulate the position of the central follower roller element 341 (serving as a central second rotating member) in the sheet width direction Dw. Furthermore, the follower roller holder 320 transmits the spring force of the pressure spring 318 to the driven shaft 344 (serving as a shaft member) via the shaft-receiving holes 320c and 320d (first shaft-receiving portion and second shaft-receiving portion) of the first side surface portion 320a and the second side surface portion 320b.

According to the above configuration, the spring force of the pressure spring 318 is transmitted from the first side surface portions 320a and 320b close to the central follower roller element 341 to the driven shaft 344. Therefore, the central follower roller element 341 can be brought into pressure contact with the drive roller elements 331 to 333 more strongly than the other follower roller elements 342 and 343. Therefore, the nip pressure in the central nip portion N1 can be increased, and the force in the sheet conveyance direction Dc applied to the document by the central drive roller element 331 and the follower roller element 341 can be further increased. As a result, in a case where the ADF 102 conveys the small-size document, even if the drawing roller pair 302 nips the document only with the central nip portion N1, the drawing roller pair 302 can feed the document against the frictional resistance received by the document at the separating portion Ns.

In other words, according to the present embodiment, it is possible to provide a sheet conveyance apparatus capable of more stably conveying a small-size sheet. According to the present embodiment, it is possible to provide the image reading apparatus 101 capable of realizing more stable conveyance of a small-size document.

Note that, in the above description, the case of the small-size document nipped only by the central nip portion N1 of the drawing roller pair 302 has been described, but a similar effect can be obtained for the small-size document whose side end portion is nipped by a part of the nip portions N2 and N3 other than the center. In other words, even in the case of a small-size document having a sheet width slightly larger than the interval W1 (FIG. 6A) between the nip portions N2 and N3 in the sheet width direction Dw, the conveyance force applied from the drawing roller pair 302 to the document at the nip portions N2 and N3 is small. Therefore, in a case where the conveyance force applied to the document by the drawing roller pair 302 at the central nip portion N1 is small, the stability of document conveyance may be deteriorated. According to the present embodiment, the document can be stably conveyed even in such a case.

Here, as a method of increasing the conveyance force in the central nip portion N1, a configuration in which two pressure springs are arranged in the vicinity of both side ends of the central follower roller element 341 (hereinafter, referred to as a comparative example) can be considered. However, in this configuration, the point of action of the spring force of the pressure springs is at a position slightly away from the conveyance center Wc in order to secure a space for attaching the pressure spring, and it is difficult to concentrate the pressing force on the central nip portion N1 accordingly. Here, concentrating the pressing force on the central nip portion N1 means increasing the ratio of the pressing force in the central nip portion N1 to the pressing force in the nip portions N2 and N3 at both ends.

On the other hand, according to the present embodiment, the spring force is transmitted to the driven shaft 344 from the first side surface portion 320a and the second side surface portion 320b of the follower roller holder 320 in which the central follower roller element 341 is positioned. Therefore, as compared with the above-described comparative example, the action points p1 and p2 (FIG. 6A) of the spring force of the pressure spring 318 with respect to the driven shaft 344 can be brought close to the conveyance center Wc. For this reason, according to the present embodiment, the pressing force can be more concentrated on the central nip portion N1, and the small-size document can be more stably conveyed.

More specifically, the pressing force in the central nip portion N1 is preferably larger than a pressing force in any one of the nip portions (i.e., the nip portions N2 and N3 according to the present embodiment) other than the central nip portion N1 among the plurality of nip portions. However, the pressing force in the nip portion N1 is the magnitude of the force by which the drive roller element 331 and the follower roller element 341 are pressed against each other in the height direction Dh, and corresponds to the force obtained by integrating the nip pressure over the entire contact surface between the drive roller element 331 and the follower roller element 341. Further, the pressing force at the central nip portion N1 may be configured to be larger than the sum of the pressing forces at all the nip portions N2 and N3 other than the central nip portion N1 among the plurality of nip portions.

In the comparative example, due to manufacturing tolerances of the two pressure springs, the distribution of the pressing force in the nip portions N1 to N3 of the drawing roller pair 302 may become asymmetric with respect to the conveyance center Wc (hereinafter, referred to as a right-left difference of the nip pressure). For example, in a case where the pressing force in the nip portion N2 on one end side is larger than the pressing force in the nip portion N3 on the other end side, the document may turn and skew when the drawing roller pair 302 conveys an A4 size document. On the other hand, according to the present embodiment, the plurality of nip portions N1 to N3 are pressed by the spring force of one pressure spring 318 via the follower roller holder 320 and the driven shaft 344. Therefore, it is possible to avoid a difference between the right and left of the nip pressure due to manufacturing tolerance of the pressure spring.

### Second Embodiment

A second embodiment in which the arrangement of the follower roller elements is different from that of the first embodiment will be described. Hereinafter, elements denoted with the same reference numerals as those in the first embodiment are assumed to have basically the same configurations and operations as those described in the first embodiment unless otherwise specified, and portions different from those in the first embodiment will be mainly described. In a case where the number of follower roller elements is an even number, the same configuration as that of the present embodiment can be suitably applied.

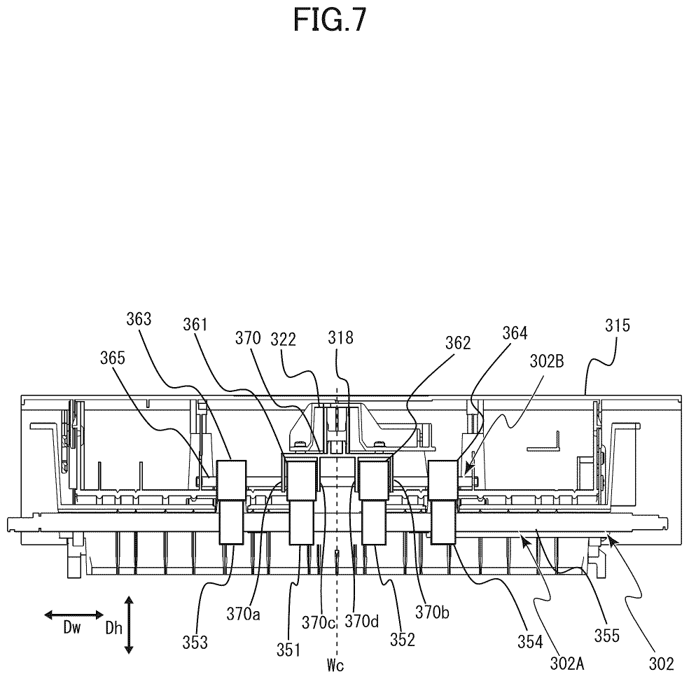

FIG. 7 is a cross-sectional view illustrating a cross section of an ADF 102 according to the present embodiment, and is a view corresponding to FIG. 6A of the first embodiment. As illustrated in FIG. 7, according to the present embodiment, a drive roller 302A includes four drive roller elements 351 to 354 as a plurality of first rotating members, and a drive shaft 355 that supports the drive roller elements 351 to 354. The follower roller 302B includes four follower roller elements 361 to 364 as a plurality of second rotating members, and a driven shaft 365 (serving as a shaft member) that supports the follower roller elements 361 to 364. Each of the driving roller elements 351 to 354 comes into contact with the driven roller elements 361 to 364 to form four nip portions.

The two follower roller elements 361 and 362 (serving as two second rotating members) at a central portion are positioned between the follower roller elements 363 and 364 at both ends in the sheet width direction Dw. Unlike the first embodiment, the two follower roller elements 361 and 362 at the central portion are both disposed at positions away from the conveyance center Wc and adjacent to each other with the conveyance center Wc interposed therebetween.

A follower roller holder 370 (serving as a holder member, a regulation member, and a shaft-receiving member) is attached to the driven shaft 365 of the follower roller 302B. The follower roller holder 370 is configured to regulate the positions of the two follower roller elements 361 and 362 at the central portion in the sheet width direction Dw and transmit the spring force of a pressure spring 318 to a driven shaft 344.

Specifically, the follower roller holder 370 according to the present embodiment includes a first side surface portion 370a, a second side surface portion 370b, a third side surface portion 370c, and a fourth side surface portion 370d. The first side surface portion 370a faces the outer end face of the follower roller element 361 in the sheet width direction Dw. The second side surface portion 370b faces the outer end face of the follower roller element 362 in the sheet width direction Dw. The third side surface portion 370c faces the inner end face of the follower roller element 361 in the sheet width direction Dw. The fourth side surface portion 370d faces the inner end face of the follower roller element 362 in the sheet width direction Dw. The positions of the two follower roller elements 361 and 362 at the central portion in the sheet width direction Dw are restricted by the first side surface portion 370a to the fourth side surface portion 370d.

A shaft-receiving hole (a first shaft-receiving portion) into which the driven shaft 365 is inserted is formed in the first side surface portion 370a. Similarly, shaft-receiving holes (a second shaft-receiving portion, a third shaft-receiving portion, and a fourth shaft-receiving portion) into which the driven shaft 365 is inserted are formed in the second side surface portion 370b, the third side surface portion 370c, and the fourth side surface portion 370d. The spring force of the pressure spring 318 is transmitted when the shaft-receiving hole abuts on the driven shaft 365.

According to the present embodiment, the sheet width of the minimum size document conveyable by the ADF 102 (i.e., a sheet having a shortest length in the sheet width direction among the sheets conveyable by the ADF 102) is shorter than the interval from the follower roller element 363 adjacent to one side of the two follower roller elements 361 and 362 at the central portion to the follower roller element 364 adjacent to the other side. Therefore, at least some small-size documents are nipped only by two nip portions at the central portion of the four nip portions included in the drawing roller pair 302. Note that the A4 size document is nipped by all of the four nip portions.

Also according to the present embodiment, the plurality of follower roller elements 361 to 364 (serving as the plurality of second rotating members) are brought into pressure contact with the plurality of drive roller elements 351 to 354 (serving as the plurality of first rotating members) by the spring force of one pressure spring 318 (serving as the urging member). The follower roller holder 370 regulates the positions of the two follower roller elements 361 and 262 (serving as two second rotating members) at the central portion in the sheet width direction Dw by the first side surface portion 370a and the second side surface portion 370b. Furthermore, the follower roller holder 370 transmits the spring force of the pressure spring 318 to the driven shaft 365 (serving as a shaft member) via the shaft-receiving holes (serving as a first shaft-receiving portion and a second shaft-receiving portion) of the first side surface portion 370a and the second side surface portion 370b.

According to the above configuration, similarly to the first embodiment, the pressing force of the two follower roller elements 361 and 362 at the central portion can be made stronger than the pressing force of the other follower roller elements 363 and 364. Therefore, similarly to the first embodiment, according to the present embodiment, it is possible to provide a sheet conveyance apparatus capable of more stably conveying a small-size sheet. According to the present embodiment, it is possible to provide the image reading apparatus 101 capable of realizing more stable conveyance of a small-size document.

### Other Embodiments

In each of the embodiments described above, the configuration example in which the present technology is applied to the ADF 102 which is a sheet conveyance apparatus that conveys a document in the image reading apparatus 101 has been described. The present technology is not limited thereto, and may be applied to, for example, a sheet conveyance apparatus that conveys a sheet used as a recording material in an image forming apparatus.

According to the present disclosure, it is possible to provide a sheet conveyance apparatus capable of more stably conveying a small-size sheet.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-078952, filed May 14, 2024, which is hereby incorporated by reference herein in its entirety.

What is claimed is:

1. A sheet conveyance apparatus comprising:
a conveyance member configured to convey a sheet;
a separation member configured to form a separating portion together with the conveyance member and separate sheets one by one in the separating portion;
a drive roller disposed downstream of the separating portion in a sheet conveyance direction, the drive roller including a plurality of first rotating members arranged in a sheet width direction orthogonal to the sheet conveyance direction;
a motor configured to drive the drive roller,
a follower roller configured to rotate following the drive roller, the follower roller including a plurality of second rotating members that come into contact with the plurality of first rotating members respectively and a shaft member supporting the plurality of second rotating members;
a holder member configured to regulate a position of a central second rotating member disposed at a center in the sheet width direction among the plurality of second rotating members; and
an urging spring configured to urge the holder member such that the plurality of second rotating members is brought into pressure contact with the plurality of first rotating members,
wherein the holder member includes (i) a first side surface portion facing an end face on one side of the central second rotating member in the sheet width direction and provided with a first shaft-receiving portion that receives the shaft member and (ii) a second side surface portion facing an end face on another side of the central second rotating member in the sheet width direction and provided with a second shaft-receiving portion that receives the shaft member, and
wherein the holder member is configured to regulate the position of the central second rotating member in the sheet width direction by the first side surface portion and the second side surface portion and apply an urging force of the urging spring to the shaft member via the first shaft-receiving portion and the second shaft-receiving portion.

2. The sheet conveyance apparatus according to claim 1,
wherein the urging spring is the only urging spring by which the follower roller is urged such that the plurality of first rotating members and the plurality of second rotating members are brought into pressure contact with each other.

3. The sheet conveyance apparatus according to claim 1,
wherein the central second rotating member, the holder member, and the urging spring are disposed at a center, in the sheet width direction, of a conveyance path where the sheet passes through.

4. The sheet conveyance apparatus according to claim 1,
wherein a pressing force in a central nip portion among a plurality of nip portions formed by the plurality of first rotating members and the plurality of second rotating members is larger than a pressing force in any one of the plurality of nip portions other than the central nip portion.

5. The sheet conveyance apparatus according to claim 4,
wherein the pressing force in the central nip portion is larger than a sum of pressing forces in all of the plurality of nip portions other than the central nip portion.

6. The sheet conveyance apparatus according to claim 1, further comprising:
a first frame including a first guide portion that is configured to form a conveyance path of the sheet, the first frame supporting the drive roller, and
a second frame including a second guide portion that is configured to form the conveyance path together with the first guide portion, the second frame being movable with respect to the first frame such that the conveyance path is opened,
wherein the holder member is supported by the second frame and is movable with respect to the second frame such that a rotation axis of the follower roller approaches to and moves away from a rotation axis of the drive roller.

7. The sheet conveyance apparatus according to claim 6,
wherein the second frame is provided with a guide shape extending in a direction intersecting with both the sheet conveyance direction and the sheet width direction,
wherein the holder member includes a guided portion to engage with the guide shape, and
wherein a position of the holder member in the sheet width direction is regulated by engagement between the guide shape and the guided portion.

8. The sheet conveyance apparatus according to claim 7,
wherein the guide shape is disposed upstream of the holder member in the sheet conveyance direction,
wherein the second frame is further provided with a second guide shape disposed downstream of the holder member in the sheet conveyance direction, and
wherein the position of the holder member in the sheet conveyance direction is regulated by the guide shape and the second guide shape.

9. The sheet conveyance apparatus according to claim 1,
wherein the holder member includes a base portion extending in the sheet width direction,
wherein the first side surface portion and the second side surface portion extend respectively from one end and another end of the base portion in the sheet width direction, toward a direction intersecting both the sheet width direction and the sheet conveyance direction, and
wherein the base portion is provided with a pressed region to receive the urging force of the urging spring.

10. The sheet conveyance apparatus according to claim 9,
wherein the holder member further includes a rib portion protruding from the base portion and formed to extend in the sheet width direction between the first side surface portion and the second side surface portion.

11. The sheet conveyance apparatus according to claim 1,
wherein a length, in the sheet width direction, of a sheet having a shortest length in the sheet width direction among sheets conveyable by the sheet conveyance apparatus is shorter than an interval, in the sheet width direction, from one of the plurality of second rotating members adjacent to one side of the central second rotating member to another of the plurality of second rotating members adjacent to another side of the central second rotating member.

12. An image reading apparatus comprising:
the sheet conveyance apparatus according to claim 1; and
a reading unit configured to read an image from a sheet conveyed by the sheet conveyance apparatus.

13. An image forming apparatus comprising:
the image reading apparatus according to claim 12; and
an image forming portion configured to form an image on a recording material,
wherein the image forming apparatus is configured to form the image on the recording material based on image information acquired by the image reading apparatus.

14. A sheet conveyance apparatus comprising:
a conveyance member configured to convey a sheet;
a separation member configured to form a separating portion together with the conveyance member and separate sheets one by one in the separating portion;
a drive roller disposed downstream of the separating portion in a sheet conveyance direction, the drive roller including a plurality of first rotating members arranged in a sheet width direction orthogonal to the sheet conveyance direction;
a motor configured to drive the drive roller,
a follower roller configured to rotate following the drive roller, the follower roller including a plurality of second rotating members that come into contact with the plurality of first rotating members respectively and a shaft member supporting the plurality of second rotating members;
a holder member configured to regulate positions of two second rotating members disposed at a central portion in the sheet width direction among the plurality of second rotating members; and
an urging spring configured to urge the holder member such that the plurality of second rotating members is brought into pressure contact with the plurality of first rotating members,
wherein the holder member includes (i) a first side surface portion facing one of the two second rotating members in the sheet width direction and provided with a first shaft-receiving portion that receives the shaft member and (ii) a second side surface portion facing another of the two second rotating members in the sheet width direction and provided with a second shaft-receiving portion that receives the shaft member, and
wherein the holder member is configured to regulate the positions of the two second rotating members in the sheet width direction by the first side surface portion and the second side surface portion and apply an urging force of the urging spring to the shaft member via the first shaft-receiving portion and the second shaft-receiving portion.

15. The sheet conveyance apparatus according to claim 14,
wherein the urging spring is the only urging spring by which the follower roller is urged such that the plurality of first rotating members and the plurality of second rotating members are brought into pressure contact with each other.

16. The sheet conveyance apparatus according to claim 14,
wherein the two second rotating members are positioned next to each other across a center, in the sheet width direction, of a conveyance path through which the sheet is conveyed, and
wherein the holder member and the urging spring are disposed at the center of the conveyance path in the sheet width direction.

17. The sheet conveyance apparatus according to claim 14,
wherein a length, in the sheet width direction, of a sheet having a shortest length in the sheet width direction among sheets conveyable by the sheet conveyance apparatus is shorter than an interval, in the sheet width direction, from one of the plurality of second rotating members to one side of the two second rotating members to another of the plurality of second rotating members adjacent to another side of the two second rotating members.

18. A sheet conveyance apparatus comprising:
a conveyance member configured to convey a sheet;
a separation member configured to form a separating portion together with the conveyance member and separate sheets one by one in the separating portion;
a drive roller disposed downstream of the separating portion in a sheet conveyance direction, the drive roller including a plurality of first rotating members arranged in a sheet width direction orthogonal to the sheet conveyance direction;
a motor configured to drive the drive roller,
a follower roller configured to rotate following the drive roller, the follower roller including a plurality of second rotating members that come into contact with the plurality of first rotating members respectively and a shaft member supporting the plurality of second rotating members;
a holder member configured to cover, from a side opposite to the drive roller, a central second rotating member disposed at a center in the sheet width direction among the plurality of second rotating members; and
an urging spring configured to urge the holder member such that the plurality of second rotating members is brought into pressure contact with the plurality of first rotating members,
wherein the urging spring is the only urging spring by which the follower roller is urged such that the plurality of first rotating members and the plurality of second rotating members are brought into pressure contact with each other.

19. The sheet conveyance apparatus according to claim 18,
wherein the holder member includes (i) a first side surface portion facing an end face on one side in the sheet width direction of the central second rotating member and provided with a first shaft-receiving portion that receives the shaft member and (ii) a second side surface portion facing an end face on another side in the sheet width direction of the central second rotating member and provided with a second shaft-receiving portion that receives the shaft member, and
wherein the holder member is configured to apply an urging force of the urging spring to the shaft member via the first shaft-receiving portion and the second shaft-receiving portion.

20. The sheet conveyance apparatus according to claim 19,
wherein the holder member includes a base portion extending in the sheet width direction,
wherein the first side surface portion and the second side surface portion extend respectively from one end and another end of the base portion in the sheet width direction, toward a direction intersecting both the sheet width direction and the sheet conveyance direction, and
wherein the base portion is provided with a pressed region to receive the urging force of the urging spring.
